(19) United States
(12) Patent Application Publication
(10) Pub. No.: US 2014/0157287 A1
(43) Pub. Date: Jun. 5, 2014

(54) Optimized Context Switching for Long-Running Processes

(71) Applicant: ADVANCED MICRO DEVICES, INC, Sunnyvale, CA (US)

(72) Inventors: Lee W. HOWES, Austin, TX (US); Benedict R. GASTER, Santa Cruz, CA (US); Michael MANTOR, Orlando, FL (US)

(73) Assignee: Advanced Micro Devices, Inc, Sunnyvale, CA (US)

(21) Appl. No.: 13/691,066

(22) Filed: Nov. 30, 2012

(51) Int. Cl. G06F 9/46

(52) U.S. Cl. CPC G06F 9/461
USPC 718/108

(57) ABSTRACT

Methods, systems, and computer readable storage media embodiments allow for low overhead context switching of threads. In embodiments, applications, such as, but not limited to, iterative data-parallel applications, substantially reduce the overhead of context switching by adding a user or higher-level program configurability of a state to be saved upon preempting of a executing thread. These methods, systems, and computer readable storage media include aspects of running a group of threads on a processor, saving state information by respective threads in the group in response to a signal from a scheduler, and pre-empting running of the group after the saving of the state information.

### BACKGROUND

1. Technical Field

The disclosed embodiments relate generally to context switching of processes.

2. Background Art

Graphics processing units (GPU) generally comprise multiple processing elements that are ideally suited for executing the same instruction on parallel data streams, as in the case of a single instruction multiple data (SIMD) device, or in data-parallel processing. In many computing models, a central processing unit (CPU) functions as the host or controlling processor and hands-off specialized functions, such as graphics processing, to other processors such as GPUs.

Multi-core CPUs, where each CPU has multiple processing cores, offer processing capabilities for specialized functions (e.g., graphics processing) similar to those available on the GPU. One or more of the computation cores of multi-core CPUs or GPUs can be part of the same die (e.g., AMD Fusion™) or, alternatively, in different dies (e.g., Intel Xeon™ with NVIDIA GPU). Recently, hybrid cores having characteristics of both CPU and GPU (e.g., AMD Accelerated Processing Units (APUs), CellSPE™, Intel Larrabee™) have been proposed for general purpose GPU (GPGPU) style computing. The GPGPU style of computing advocates using the CPU to primarily execute control code and to offload performance critical data-parallel code to the GPU. The GPU is primarily used as an accelerator. The combination of multi-core CPUs and GPGPU computing model encompasses both CPU cores and GPU cores as accelerator targets.

Several frameworks have been developed for heterogeneous computing platforms that have CPUs and GPUs. These frameworks include BrookGPU by Stanford University, the compute unified device architecture (CUDA) by NVIDIA, and OpenCL by an industry consortium named Khronos Group. The OpenCL framework offers a C-like development environment which users can create applications for the GPU. OpenCL enables the user, for example, to specify instructions for offloading some computations, such as data-parallel computations, to a GPU. OpenCL also provides a compiler and a runtime environment in which code can be compiled and executed within a heterogeneous, or other, computing system.

The computing model embodied by OpenCL, CUDA and many low level GPU intermediate languages, is sometimes known as a single instruction multiple thread (“SIMT”) processing. In a frequently used implementation of the SIMT model, SIMD execution using hardware mask sets on vectors is used to simulate threading to a finer grain than what is available in the hardware.

In many processing environments, including in the processors and frameworks noted above, the ability to control the maximum duration any particular process or group of processes occupy a processor is important to system performance. The scheduler seeks to be able to execute processes in a manner that satisfies various timing requirements. For example, if a long running thread occupies the processor for a long duration preventing other processes from executing, the user may sense a lack of responsiveness in the system and/or a second process waiting to be executed may not satisfy its timing constraints. The long running thread may be a serially executing rendering activity that results in the display being unresponsive. In order to ensure that the system runs at an appropriate level of responsiveness, the scheduler can initiate a context switch from the current running process to another process. The context switch is either performed after the long-running process runs to an end, or alternatively, is performed by hardware.

However, context switching only after a long-running process runs to an end or alternatively performing hardware-based context switching both can negatively affect system performance. Waiting for a long-running process to run to an end does not bound the time that the new process must wait to be started. Hardware-based context switching involves saving and restoring very large amounts of state information. For example, the context switch hardware may simply save the entire register memory content of the currently executing process as the saved state information. When data-parallel processes that have large numbers of concurrently executing threads on multiple processing units are context switched, the amount of context saved is even larger, leading to degraded performance. Thus, methods and systems for efficient context switching are desired.

### SUMMARY OF EMBODIMENTS

Methods, systems, and computer readable storage media embodiments allow for low overhead context switching of threads. In embodiments, applications, such as, but not limited to, iterative data-parallel applications, substantially reduce the overhead of context switching by adding a user or higher-level program configurability of a state to be saved upon preempting of a executing thread. These methods, systems, and computer readable storage media include aspects of running a group of threads on a processor, saving state information by respective threads in the group in response to a signal from a scheduler, and pre-empting running of the group after the saving of the state information.

Further embodiments, features, and advantages of the disclosed embodiments, as well as the structure and operation of the disclosed embodiments, are described in detail below with reference to the accompanying drawings.

### BRIEF DESCRIPTION OF THE DRAWINGS/FIGURES

The accompanying drawings, which are incorporated in and constitute part of the specification, illustrate embodiments and, together with the general description given above and the detailed description of the embodiment given below, serve to explain the principles of the embodiments. In the drawings:

FIGS. 1A and 1B illustrate example conventional techniques in pseudo code for reduction operations.

FIGS. 2A-2C illustrate programs in pseudo code for data-parallel iterative operations, according to embodiments.

FIG. 3 illustrates a flowchart of a method for optimized context saving by a workgroup, according to some embodiments.

FIG. 4 illustrates a flowchart of a method for resuming a workgroup with previously saved selective context, in accordance with some embodiments.

FIG. 5 illustrates a block diagram of a system for optimized context switching, according to some embodiments.

FIG. 6 illustrates a block diagram of an optimized context switching module, according to some embodiments.

### DETAILED DESCRIPTION OF EMBODIMENTS

While the embodiments are described herein are for particular applications, it should be understood that the disclosed embodiments are not limited thereto. Those skilled in the art with access to the teachings provided herein will recognize additional modifications, applications, and embodiments within the scope thereof and additional fields in which the disclosed embodiments would be of significant utility.

Embodiments may be used in any computer system, computing device, entertainment system, media system, game systems, communication device, personal digital assistant, or any system using one or more processors. Each of these computer systems may comprise a heterogeneous computing system. A “heterogeneous computing system,” as the term is used herein, is a computing system in which multiple kinds of processors are available.

In a GPU, workitems assigned to a processing element are referred to as a “workgroup”. Two or more workitems that are issued for execution in parallel is a “wavefront”. A workgroup may comprise one or more wavefronts. Although embodiments are primarily described in relation to workitems of a workgroup, the teachings of this disclosure may be applied to workitems across any one or more processors and/or groups of processes. The term “kernel”, as used herein, refers to a program and/or processing logic that is executed as one or more workitems in parallel having the same code base. As used herein, the terms “workitem” and “thread” are interchangeable. The interchangeability, in this disclosure, of “workitem” and “thread” is illustrative, for example, of the flexible simulated or true independence of workitem execution embodied in the model in embodiments.

Embodiments can significantly improve the performance of systems by enabling more efficient and more flexible context switching of threads. In a GPU, multi-core CPU, or other processor that executes each process as a large number of concurrent threads, for example, using a SIMD or SIMT framework, the embodiments improve efficiency by enabling each process to optimally context switch by saving only the required context when context switching is required. The optimal context switch is determined in accordance with user and/or compiler programmable points in the source code and by hardware-based signaling. Moreover, in some embodiments, a process may set a register indicating to a scheduler that the process has the capability to be context switched at user and/or compiler programmable points in the code. The scheduler can therefore selectively determine whether to apply hardware-based context switching or context switch in accordance with this disclosure. For example, context switching in accordance with this disclosure may be selectively performed for long running iterative processes, such as, but not limited to, reduction processes.

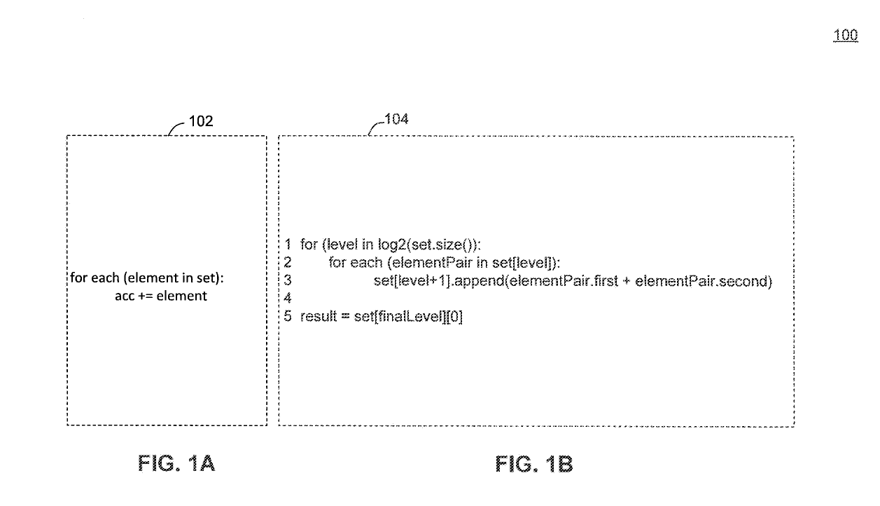

FIGS. 1A and 1B illustrate example conventional programs in pseudo code for an example application. For example, the application illustrated in FIGS. 1A and 1B is referred to as a “reduction operation.”

In FIG. 1A, code block 102 illustrates pseudo code for a basic reduction operation in which a set of elements is summed to an accumulator variable (“acc”). At each iteration of the for loop, a respective element from the set is selected and added to acc. The variable acc maintains a running sum of the added elements.

Code block 102 is a reduction operation that is executed serially. Based upon the size of the initial input list, the serial reduction operation can occupy the processor for varying lengths of time until the entire list of inputs is reduced to one result, e.g., the final sum in acc.

The code block 104 shown in FIG. 1B exemplifies a conventional approach to parallelize code block 102 to execute on a platform such as a SIMD or SIMT platform.

For example, given a list of inputs, each concurrently executing thread sums a respective subsequence of the input list. The partial sums of input subsequences are then summed by summing a pair of partial sums together. At each step (or level of summation) the number of partial sums is reduced by half. After log₂ N (where N is the number of inputs in the original list to be summed) a final sum is produced.

Prior to the first line in code block 102, the “set” may have been initialized to include all elements of a plurality of elements as the input. The initial level may be considered as level 0. Each of the elements (“elementPair” in the code) at level 0 may be processed by a separate thread in a plurality of concurrently executing threads. The instruction at line 3 of code block 104 is executed for each element at every level. The instruction at line 3 creates a list of elements for the next level that is half the size of the current level. At the end of the loop, when the instruction at line 3 has been executed for each level 0 . . . log₂ N and for each element at each level, the loop terminates. The sum that is stored in the first element of the final level is the reduced sum that is returned as the result.

As illustrated in code block 104, each element at each level can be implemented as a separate thread. Therefore, code block 104 can represent a massively parallel implementation of a reduction operation.

Serial reduction techniques, such as that illustrated in code block 102, can take a long duration to complete the reduction operation when the input list is large. Taking a long duration to complete the operation precludes other processes from using the processing resources. Therefore, when a long running serial operation occupies the processor for a long period of time, system responsiveness may decrease. For example, one or more other processes will be blocked from execution until the long thinning serial process completes execution.

The conventional massively parallel approach shown in code block 104 may yield much faster completion times than code block 102 because of the parallel execution. However, because the execution is distributed between a large number of threads, there may be substantial amounts of data being transmitted between memory locations. The extensive transmission of memory content may result in performance degradation of the entire system.

Thus, an alternative approach is proposed in this application, where selected operations are performed serially, while allowing those serial processes to be context switched with a low overhead. In one example, the embodiments allow a reduction operation having as one serial operation per core and a short reduction tree to accumulate a final result between the cores.

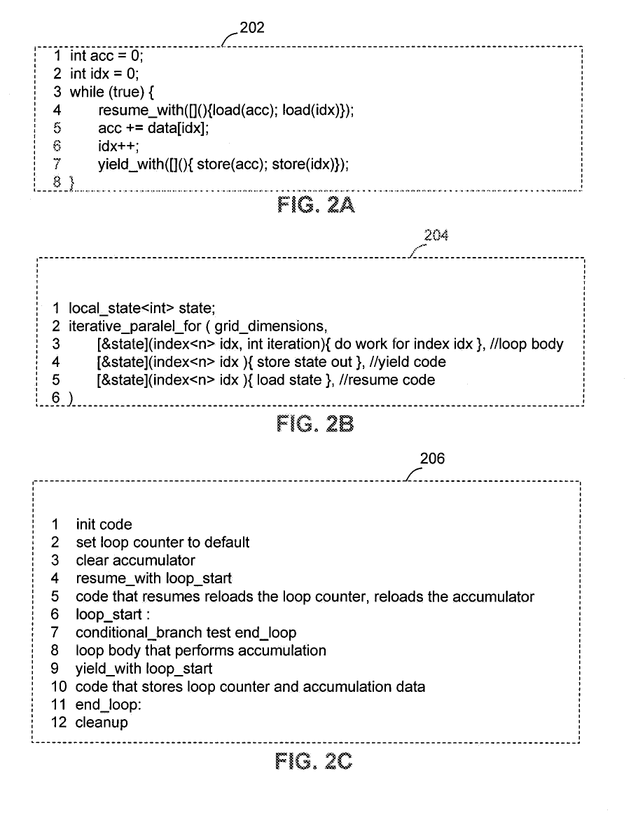

FIGS. 2A-2C illustrate programs in pseudo code for example data-parallel iterative operations, according to some embodiments.

Code block 202 shown in FIG. 2A illustrates the use of “yield_with” and “resume_with” instructions, in accordance with some embodiments. The iterative loop, in this case a while loop, keeps iterating by adding a value from an array ‘data’ to an accumulator variable ‘acc’. The yield_with is run in each iteration of the loop. The yield_with tests a condition that indicates to the current process in which the iterative loop is being executed whether the processor should be yielded. If the current process determines that it has to yield the processor, then the yield_with calls a block of code that selectively saves state information of the process. The state information that is saved can be the minimal amount of state information needed for the subsequent resumption of the process, and may be different from the entire current state of the process. For example, the entire current state may include all of the register state, whereas the minimal state may include only a few variables, counters or other values that are necessary for the process to be subsequently resumed. In the example code block 202, the state information that is saved before the process switches is the current value of the acc variable and the current value of the idx variable. The variable idx maintains a count of the number of times the while loop has iterated, and is used, for example, as an index into the array ‘data’. After saving the state information, the process can exit the while loop or can set a condition indicating that the process is ready to be switched out of the processor. Also, a resume_with instruction may be called within the while loop. The resume_with tests whether the current process is a new process (e.g., no previously saved state information is available) or is a previously context switched process being resumed (e.g., previously saved state information is available). If no previous state information is found, then no changes to the current state is made and the process proceeds to execute instructions within the while loop. If previously saved state information is available, then the code associated with the resume_with loads the previously stored state as the current state of the process. In the example shown, resume_with loads the previous saved values of the variables acc and idx into the current state of the process.

In one example, code block 204 shown in FIG. 2B illustrates a high-level code template for an iterative data-parallel application such as, but not limited to, a reduction operation. Code block 204 is illustrative of an iterative parallel function equivalent of a “parallel_for” (e.g., a parallel implementation of a “for” loop) function. In this example, the “iterative_parallel_for” is a function accepting four inputs. The inputs include “grid_dimensions,” which enables the function to size itself to the size of the currently running application. For example, if the iterative_parallel_for is intended to start 16×16 threads on a GPU, then the grid dimensions may be passed as 16 or (16,16).

In this example, the iterative_parallel_for also includes three function inputs. The first function input is a function that is called repeatedly to perform work for one or more items identified by an index. The index is incremented each time the function is called. The second function input is a function to store state information to memory when a yield (e.g., a request for the process to switch out of the processor) is requested between iterations. The third function input is a function that is called to resume the thread when the thread is reissued to the hardware. The third function, as illustrated, loads the state information that was previously stored by the second input function. In addition to the state information captured and stored by the yield function and restored by the resume function, the index state may also be required to be saved with the context.

When the scheduler requests a yield, a user- or high-level-language generated function is run to store exactly what is necessary and no more. It is not necessary to store the full register file or local memory region. In the above example, the only state information needed to be stored represents the current iteration index, the current thread identifier (which is the scheduler's job to push back onto a work queue), and the accumulator itself. New data to add to the accumulator can be computed from the above variables, either because the data is still in registers or because the data has been placed back in registers by executing the resume code.

In one example, code block 206 shown in FIG. 2C illustrates a high-level pseudo code for an iterative data-parallel application, such as a reduction operation.

In lines 1-3 of the code block 206, initialization code is executed, a loop counter is set to a default value, and an accumulator is initialized. A person of skill in the art would appreciate that the code block 206 is an example and that embodiments may have other forms of code block 206 with similar functionality. Although initialization is shown as line 1 of the above code, a person of skill in the relevant arts would appreciate that initialization code can be any number of lines. Moreover, the resetting of the loop counter and accumulator, shown respectively as lines 2-3 of code block 206, may occur in other orderings of instructions in code block 206.

At line 4, the resume instruction branches to a loop_start (line 6) unless the process is in a resume context, at which point it runs the code at line 5. The code illustrated at line 5 represents the code that resumes the process when the process is rescheduled for execution. The resume code may include reloading the loop counter and the accumulator from previously stored state information. After the resume code at line 5, the next instruction is the loop_start.

The code under the loop_start label includes the body of the loop. The loop may be considered the code that performs the main computations of the process. At line 7, a conditional branch instruction is executed on a ‘test’ condition. If the ‘test’ condition is satisfied the loop is terminated, processing proceeds to the end_loop label at line 11. If, at line 7 the ‘test’ condition is not satisfied, the next line of instruction that includes the loop body is executed. As shown in line 8, the loop body, possibly among other instructions, performs the accumulation (e.g., adding a value to an accumulator variable).

In this example, in each loop iteration, as shown in line 9, a yield_with instruction is executed. The yield_with tests a condition to determine whether the current process is required to yield the processor. If yes (i.e., required to yield), then the code in line 10 is executed to store the minimum amount of state information by saving the loop counter and the accumulation data. If, the yield_with does not detect a requirement to yield, then, as shown in line 9, the processing iterates back to loop_start.

The instruction at line 11, the end_loop label, is reached either subsequent to executing the state saving code at line 10, or having the conditional branch instruction at line 7 satisfy the test condition. At lines 11 and 12 of the code, any cleanup instructions can be executed before the process completes execution.

A resume_with_{—} instruction (line 4) may be used to watch the resume state in a register that notifies the runtime that this instance of a thread is a re-entry from a previous yield. If the register is set, the thread will enter the block, otherwise the thread will branch to the target. Based upon the yield_with instruction (line 9), the thread will enter the block represented at line 10 if the yield register is set, otherwise the thread branches over line 10 to the target at line 11. The overhead imposed on a thread by these yield and resume operations is low. For example, as illustrated in FIG. 2C, what the yield and resume operations require is one test during each iteration of the loop and a predictable defaulted branch target.

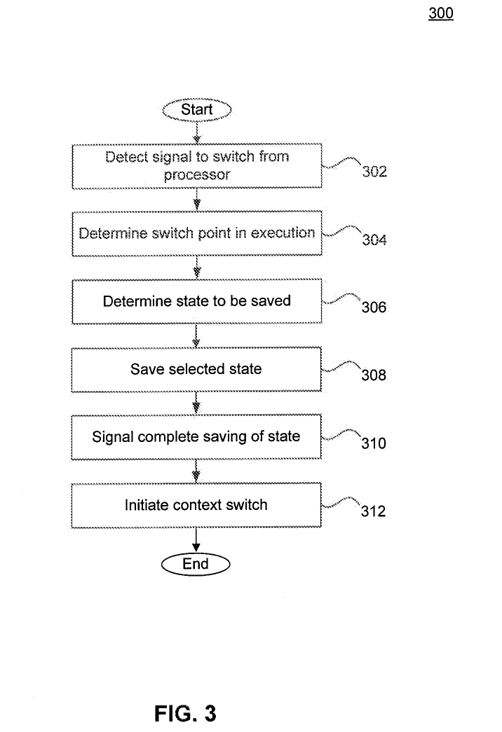

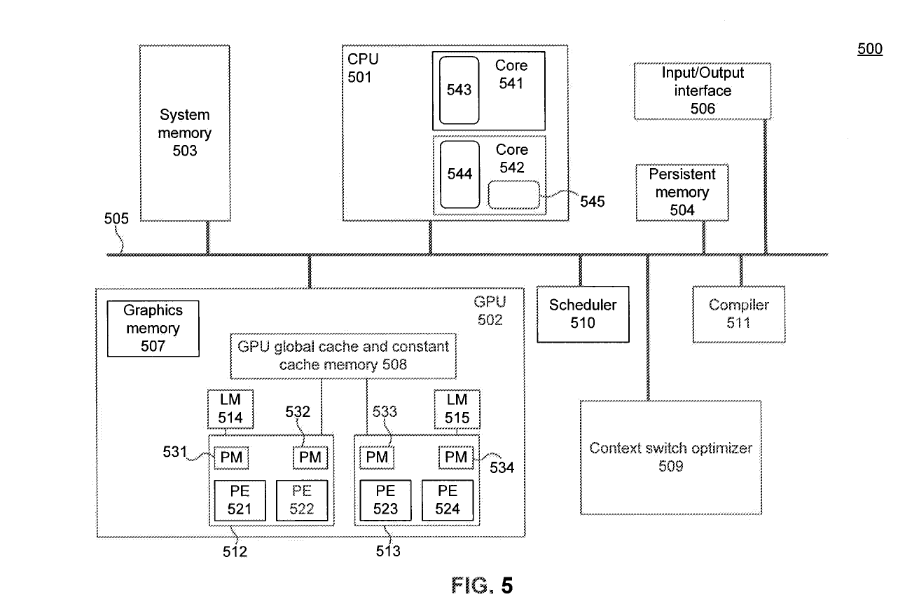

FIG. 3 illustrates a flowchart of a method 300 for context saving by a workgroup, according to some embodiments. All of the steps 302-312 may not be required, and steps 302-312 may be performed according to an ordering that is different from that illustrated in FIG. 3. Method 300 can be performed, for example, in context switch optimizer 509 described in relation to FIG. 5 below. Method 300 enables processes, workgroups, or wavefronts of threads to be context switched in a manner that is highly efficient with respect to an amount of state information saved for each context switch.

Method 300 may be performed by a currently executing process or corresponding group of threads on a processor. According to some embodiments, each concurrently executing thread in a workgroup or other thread group independently performs method 300 on a processing unit.

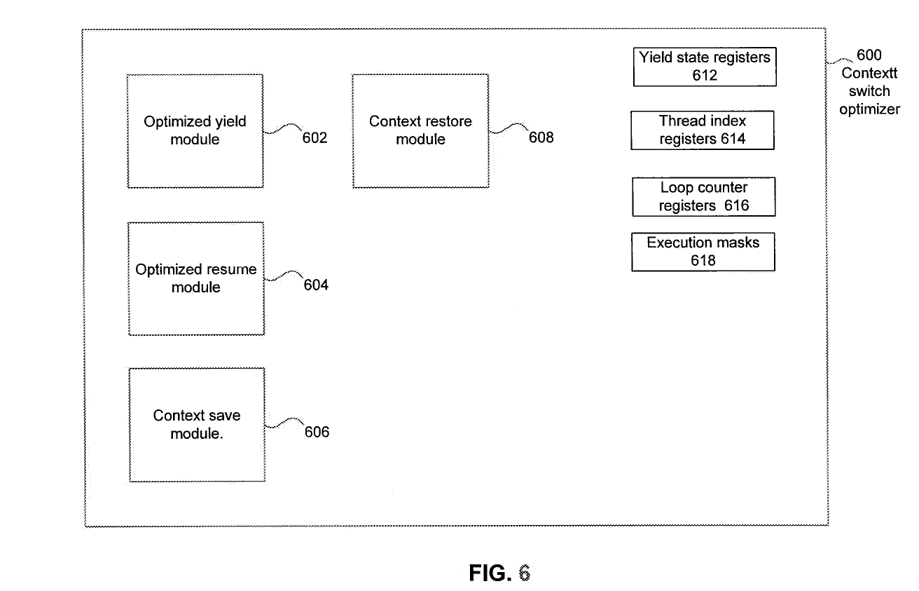

At step 302, a signal is detected by the currently running process indicating that the currently running process should switch out of the processor. The detection may be based upon reading a value of a register, such as a yield state register 612 shown in FIG. 6. The register may indicate a respective yield state for each of the currently executing threads. For example, each thread identified by a respective thread index may have a corresponding yield state bit in the register. The setting of the yield state register may be performed by any entity, such as but not limited to a scheduler, in the system with the responsibility of managing execution of processes in the system.

The scheduler, for example, scheduler 510 shown in FIG. 5, may set the yield state register 612 (FIG. 6) based upon a determination that another process should be scheduled for execution. The determination to execute another process by preempting and/or context switching the currently running process may be made by the scheduler based upon considerations, such as, but not limited to, process priority, slice of processor time assigned to the respective processes, the amount of time the processes have occupied the processor, and/or other like factors.

The detection may be performed independently by each of the currently executing threads. The detection can be a result of executing a yield_{—} with instruction in the sequence of instructions that is executed in the course of the thread's execution. As described above, a yield_with instruction may cause a register or other memory location to be read in order to determine whether another entity has requested the currently running process or thread to switch out of the processor.

If the thread does not detect that it is being requested to switch out of the processor (e.g., yield_state register 612 (FIG. 6) does not indicate that a switch out has been requested), then processing continues with the instruction following the yield_with instruction in the instruction stream.

If, however, the thread does detect that it is being requested to yield (e.g., switch out of the processor), then at step 304 the thread determines a point at which it would switch out. In some embodiments, the thread would switch at the current location in the instruction stream. For example, the switch may be initiated with or within the yield_with instruction upon detecting that a switch has been requested. In some embodiments, the thread may continue execution until a more desirable location in the execution is reached for switching out of the processor. For example, upon execution of the yield_with instruction and determining that the thread should be switched out, the thread may continue to a location in the code that may be selected for reasons, such as, but not limited to, a location at which the thread is determined to have less state information than at the location of the yield_with instruction.

In example embodiments, the thread, upon executing the yield_with instruction and detecting that it has been requested to switch out of the processor, may still determine that it is in an intermediate state of a computation. The thread may determine to continue execution until the computation is resolved by executing one or more instructions.

At step 306, the state information that is desired to be saved is determined. According to some embodiments, it is desired to save only the minimum amount of state information required to subsequently resume the thread. In the example shown in code block 202 of FIG. 2A, only the accumulator is to be stored. Some embodiments may select additional state information to be saved. By causing the yield_with instruction to call a user- or higher-level code block when it is required to yield, embodiments enable a user or higher-level analysis software to determine an optimal yield point. In some embodiments, the optimal yield point is a point in the execution of the kernel or process that has a reduced, or minimized, amount of state information that needs to be saved.

For example, during the execution of a loop, each iteration may perform one or more computations yielding a unified result at the end of the iteration. Then, the state of the process that is required to be saved at a midpoint in an iteration can include data from the intermediate computations, whereas at the end of the iteration the only state information needed may be the unified result. A user or higher level program, such as a compiler or code analyzer, may determine one or more such points at which to insert yield_with instructions. Moreover, a code block called by the yield_with can determine the state information to be stored, such that only the state information necessary for the process to be resumed is stored. At step 308, the determined state information is saved. As described above, the state information determined or selected to be saved is substantially a minimum amount of state necessary for the process or thread to be resumed. The selected context can be saved for each respective thread. In some embodiments, the amount of time required to save the state information in any type of thread is likely to be less than the time taken in saving the state information conventionally. This is due to the often large difference in the size of state information saved in embodiments as compared to conventional techniques, which saves the entire content of selected memories as the context associated with the thread.

At optional step 310, the thread signals that the saving of state has completed. This optional signal can be used if the scheduler or other process is initiating the context switch. For example, the signal can be used by the scheduler to prepare the second process to be context switched.

At step 312, the context switch is initiated. The initiation of the context switch can be by the scheduler, other process, or by the thread being switched out. The context switch may be completed by the currently executing process yielding the processor and a new process being run on the same processor.

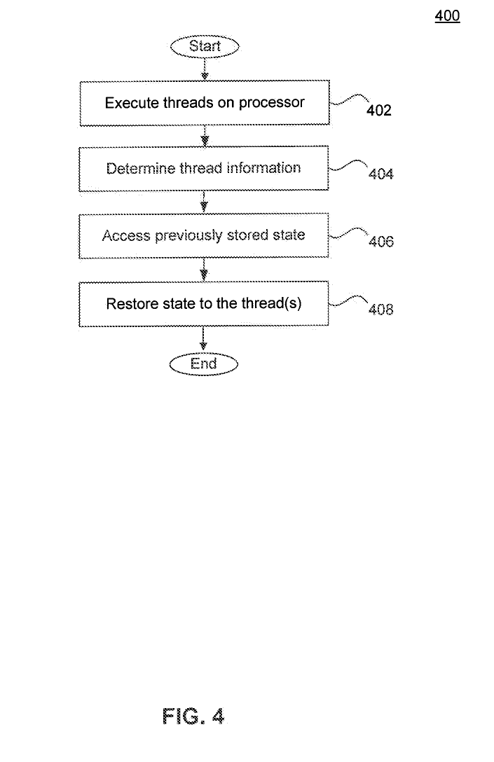

FIG. 4 illustrates a flowchart of a method 400 for resuming running or processing of a workgroup with previously saved selective context, according to some embodiments. All of the steps 402-406 may not be required, and steps 402-406 may be performed according to an ordering that is different from that illustrated in FIG. 4. Method 400 can be performed, for example, in context switch optimizer 509 described in relation to FIG. 5 below. Method 400 enables processes, workgroups, wavefronts, or other groups of threads to be context switched in a manner which is highly efficient in terms of the state information saved for each context switch.

At step 402, the process begins executing on the processor after being rescheduled by the scheduler. According to some embodiments, after the scheduler requests yielding the processor, the scheduler enqueues each process in a task queue from which tasks are selected for execution as processes on selected processors.

At step 404, each executing thread determines the respective thread information.

The thread information can, for example, include a respective thread index. According to some embodiments, the scheduler enqueues the process with information regarding the range of thread indices based upon the thread information of the previously yielded threads.

At step 406, each thread accesses the respective previously stored state information. According to some embodiments, the thread encounters a resume_with instruction. A code block associated with the resume_with includes an access to previously saved state information for the respective threads.

At step 408, the previously stored state information is restored to the resumed threads. According to some embodiments, a code block called from a resume with instruction reads the previously saved state information of each thread and restores the respective threads to execute from a position consistent with the point at which the each respective thread was previously preempted for context switching.

FIG. 5 is a block diagram illustration of a system for context switching, in accordance with some embodiments. In FIG. 5, an example heterogeneous computing system 500 can include one or more CPUs, such as CPU 501, and one or more GPUs, such as GPU 502. Heterogeneous computing system 500 can also include system memory 503, persistent memory 504, system bus 505, an input/output interface 506, a context switch optimizer 509, a scheduler 510, and a compiler 511.

CPU 501 can include a commercially available control processor or a custom control processor. CPU 501, for example, executes the control logic that controls the operation of heterogeneous computing system 500. CPU 501 can be a multi-core CPU, such as a multi-core CPU with two CPU cores 541 and 542. CPU 501, in addition to any control circuitry, includes CPU cache memories 543 and 544 of CPU cores 541 and 542, respectively. CPU cache memories 543 and 544 can be used to temporarily store instructions and/or parameter values during the execution of an application on CPU cores 541 and 542, respectively.

For example, CPU cache memory 543 can be used to temporarily store one or more control logic instructions, values of variables, or values of constant parameters, from the system memory 503 during the execution of control logic instructions on CPU core 541. CPU 501 can also include specialized vector instruction processing units. For example, CPU core 542 can include a Streaming SIMD Extensions (SSE) unit that can efficiently process vectored instructions. A person skilled in the art will understand that CPU 501 can include more or less than the CPU cores in the example chosen, and can also have either no cache memories, or more complex cache memory hierarchies.

GPU 502 can include a commercially available graphics processor or custom designed graphics processor. GPU 502, for example, can execute specialized code for selected functions. In general, GPU 502 can be used to execute graphics functions, such as graphics pipeline computations and rendering of image on a display.

In one example, GPU 502 includes a GPU global cache memory 508 and one or more compute units 512 and 513. A graphics memory 507 can be included in, or coupled to, GPU 502. Each compute unit 512 and 513 can be associated with a GPU local memory 514 and 515, respectively. Each compute unit can include one or more GPU processing elements (PE). For example, compute unit 512 includes GPU processing elements 521 and 522, and compute unit 513 includes GPU PEs 523 and 524.

Each GPU processing element 521, 522, 523, and 524 can be associated with at least one private memory (PM) 531, 532, 533, and 534, respectively. Each GPU PE can include one or more of a scalar and vector floating-point units. The GPU PEs can also include special purpose units, such as inverse-square root units and sine/cosine units. GPU global cache memory 508 can be coupled to a system memory, such as system memory 503, and/or graphics memory, such as graphics memory 507.

System memory 503 can include at least one non-persistent memory, such as dynamic random access memory (DRAM). System memory 503 can store processing logic instructions, constant values and variable values during execution of portions of applications or other processing logic. For example, the control logic and/or other processing logic of context switch optimizer 509 can reside within system memory 503 during execution of context switch optimizer 509 by CPU 501. The term “processing logic,” as used herein, can refer to control flow instructions, instructions for performing computations, and instructions for associated access to resources.

Persistent memory 504 can include one or more storage devices capable of storing digital data such as magnetic disk, optical disk, or flash memory. Persistent memory 504 can, for example, store at least parts of instruction logic of context switch optimizer 509. At the startup of heterogeneous computing system 500, the operating system and other application software can be loaded in to system memory 503 from persistent memory 504.

System bus 505 can include a Peripheral Component Interconnect (PCI) bus, Industry Standard Architecture (ISA) bus, or such a device. System bus 505 can also include a network, such as a local area network (LAN), along with the functionality to couple components, including components of heterogeneous computing system 500.

Input/output interface 506 includes one or more interfaces connecting user input/output devices, such as keyboard, mouse, display and/or touch screen. For example, user input can be provided through a keyboard and mouse connected input/output interface 506 to heterogeneous computing system 500. The output of heterogeneous computing system 500 can be output to a display through input/output interface 506.

Graphics memory 507 is coupled to system bus 505 and to GPU 502. Graphics memory 507 is, in general, used to store data transferred from system memory 503 for fast access by the GPU. For example, the interface between GPU 502 and graphics memory 507 can be several times faster than the system bus interface 505.

Context switch optimizer 509 includes logic for optimized context saving by a workgroup on either GPU 502 or CPU 501. Context switch optimizer 509 may be configured to provide optimized context switching of processes on each individual processor and/or within each processing element of a processor. Context switch optimizer 509 is further described in relation to FIG. 6 below.

In one example, scheduler 510 includes logic to request a currently executing process to yield the processor. According to some embodiments, scheduler 510 sets a register, such as yield state register 612 shown in FIG. 6, to request one or more currently executing processes to yield. Scheduler 510 further includes logic to context switch processes on one or more processors. Context switching may include requesting a process to yield and waiting for that process to complete saving its context, and performing hardware-based context switching. Scheduler 510 may maintain a queue of tasks to be scheduled on one or more processors. Upon context switching, scheduler 510 may schedule tasks for execution on one or both of GPU 502 and CPU 501.

In one example, compiler 511 includes logic to generate code for processes that behave in accordance with methods 300 and 400 to enable optimized context switching. According to some embodiments, compiler 511 includes yield_with and resume_with instructions, such as, for example, those described in relation to FIGS. 2A-2C, in the code as indicated by a user or higher level program. According to some embodiments, compiler 511 includes logic to analyze a program to determine points at which yield_with and resume_with instructions can be inserted in order to enable optimized context switching.

A person of skill in the art will understand context switch optimizer 509 and scheduler 510 can be implemented using software, firmware, hardware, or any combination thereof. When implemented in software, for example, context switch optimizer 509 and scheduler 510 can be a computer program, written in C or OpenCL for example, that, when compiled and executing, resides in system memory 503. In source code form and/or compiled executable form, context switch optimizer 509 and scheduler 510 can be stored in persistent memory 504. In some embodiments, some or all of the functionality of context switch optimizer 509 is specified in a hardware description language such as Verilog, RTL, netlists, to enable ultimately configuring a manufacturing process through the generation of maskworks/photomasks to generate a hardware device embodying aspects described herein. Compiler 511 may be implemented in software.

A person of skill in the art will understand that heterogeneous computing system 500 can include more or less components that shown in FIG. 5. For example, heterogeneous computing system 500 can include one or more network interfaces, and or software applications such as the OpenCL framework.

FIG. 6 is an illustration of context switch optimizer 600, according to some embodiments. Context switch optimizer 600 includes an optimized yield module 602, an optimized resume module 604, a context save module 606, and a context restore module 608. Moreover, context switch optimizer 600 can include yield state registers 612, thread index registers 614, loop counter registers 616 and execution masks 618. According to some embodiments, context switch optimizer 600 includes context switch optimizer 509.

Optimized yield module 602 operates to determine whether or not the currently executing process is required to be switched out. According to some embodiments, the currently executing process may be determined as requiring to be switched out if another entity or program has set a value in a register. According to some embodiments, optimized yield module 602 may include the logic associated with processing stages described below in relation to method 300.

Optimized resume module 604 operates to resume a process when it has been rescheduled for execution by the scheduler. According to some embodiments, optimized resume module 604 can include the logic associated with processing stages described above in relation to method 400.

Context save module 606 operates to save context of the currently executing thread. Context save module 606 may be called by optimized yield module 602 in order to save the context of the currently executing module, when optimized yield module 602 determines that it is time to yield. According to some embodiments, context save module may include the logic associated with one or more of the processing stages 306-308 described above in relation to method 300.

Context restore module 608 operates to restore the context of the currently executing thread after the thread has been rescheduled for execution. The restored context includes the context saved previously by context save module 606 before this (e.g., the currently executing process) was switched out of executing on the processor. According to some embodiments, context restore module 608 may include the logic associated with processing step 406 described above in relation to method 400.

Yield state registers 612 may be one or more data structures formed in any type of memory and/or using hardware registers. Yield state registers 612 indicate whether the currently executing process is desired to be switched out of the processor.

Thread index registers 614 may be one or more data structures formed in any type of memory and/or using hardware registers. Thread index registers 614 maintain the thread identifier for each thread. In some embodiments, thread index registers 614 maintains the status of each thread in relation to the group.

Loop counter registers 616 may be one or more data structures formed in any type of memory and/or using hardware registers. Loop counter registers 616 store the loop counter values for the respective threads.

Execution masks 618 may be one or more data structures formed in any type of memory and/or using hardware registers. Execution masks 618 may be utilized to indicate which of the threads are currently runnable.

The Summary and Abstract sections may set forth one or more but not all example embodiments as contemplated by the inventor(s), and thus, are not intended to limit the embodiments and the appended claims in any way.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept disclosed embodiments. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the disclosed embodiments should not be limited by any of the above-described example embodiments, but should be defined only in accordance with the following claims and their equivalents.

What is claimed is:

1. A method, comprising:
running a group of threads on a processor;
saving state information by respective threads in the group in response to a signal from a scheduler; and
pre-empting the running of the group after the saving.

2. The method of claim 1, wherein the saving the state information comprises:
selectively saving elements from a context of the respective threads.

3. The method of claim 1, wherein the saving the state information comprises:
detecting the signal from the scheduler;
calling a user-specified code block by each of the respective threads in response to the detected signal, wherein the code block is configured to save the state information.

4. The method of claim 3, wherein the saving the state information further comprises:
determining a point at which to yield the running by the respective threads; and
calling the code block at the determined point.

5. The method of claim 4, wherein the determining the point comprises:
determining the point in order to reduce an amount of the state information to be saved.

6. The method of claim 5, wherein the determining the point in order to reduce an amount of the state information to be saved is performed by a compiler.

7. The method of claim 5, wherein the determining the point in order to reduce an amount of the state information to be saved is performed dynamically at runtime.

8. The method of claim 1, wherein the saving state information comprises:
detecting the signal from the scheduler;
calling a compiler-generated code block by each of the respective threads in response to the detected signal, wherein the code block is configured to save the state information.

9. The method of claim 1, further comprising:
resuming the pre-empted group; and
restoring the selectively saved state information by respective threads from the resumed group.

10. The method of claim 8, wherein the restoring comprises:
reading the selectively saved state information;
determining a resume point based upon the read selectively saved state information; and
continuing running from the determined resume point.

11. The method of claim 1, further comprising:
determining by the scheduler to perform a context switch;
setting, by the scheduler in response to the determining, the signal in order to yield the running threads; and
starting another group of threads on the processor.

12. The method of claim 11, wherein the setting comprises:
selectively setting the signal for iterative applications.

13. A system, comprising:
a processor;
a group of threads executing on the processor; and
a context switching module that, in response to being executed by the processor, is configured to cause the processor to:
save state information by respective threads in the group in response to a signal from a scheduler; and
pre-empt the running of the group after the saving.

14. The system of claim 13, wherein the context switching module is configured to farther cause the processor to:
selectively save elements from a context of the respective threads.

15. The system of claim 13, wherein the context switching module is configured to further cause the processor to:
detect the signal from the scheduler;
call a user-specified code block by each of the respective threads in response to the detected signal, wherein the code block is configured to save the state information.

16. The system of claim 13, further comprising:
a resume module that, in response to being executed by the processor, is configured to cause the processor to:
resume the pre-empted group on the processor; and
restore the selectively saved state information by respective threads from the resumed group.

17. The system of claim 16, wherein the resume module is configured to further cause the processor to:
read the selectively saved state information by the respective threads;
determine a resume point based upon the read selectively saved state information; and
continue execution of the respective threads from the determined resume point.

18. A computer readable storage medium having instructions, the instructions when executed by a processor, causes the processor to execute a method comprising:
running a group of threads on a processor;
saving state information by respective threads in the group in response to a signal from a scheduler; and
pre-empting the running of the group after the saving.

19. The computer readable storage of claim 18, wherein the saving individual state comprises:
selectively saving elements from a context of each of the respective threads.

20. The computer readable storage of claim 18, wherein the method further comprises:
resuming the pre-empted group on the processor; and
restoring the selectively saved individual state information by respective threads from the resumed group.
